(19) United States
(12) Patent Application Publication
(10) Pub. No.: US 2020/0139235 A1
(43) Pub. Date: May 7, 2020

(54) DYNAMIC DASHBOARD VIDEO GAME PROCUREMENT OPTIONS

(71) Applicants: Josiah Eatedali, Los Angeles, CA (US); Jon Estanislao, South Pasadena, CA (US); Brandon Myles Zien, Sherman Oaks, CA (US)

(72) Inventors: Josiah Eatedali, Los Angeles, CA (US); Jon Estanislao, South Pasadena, CA (US); Brandon Myles Zien, Sherman Oaks, CA (US)

(21) Appl. No.: 16/672,269

(22) Filed: Nov. 1, 2019

Related U.S. Application Data
(60) Provisional application No. 62/755,284, filed on Nov. 2, 2018.

(51) Int. Cl. A63F 13/30; A63F 13/40; A63F 13/822; A63F 13/58; A63F 13/245

(52) U.S. Cl. CPC A63F 13/30; A63F 13/40; A63F 13/822; A63F 2300/807; A63F 13/245; A63F 2300/65; A63F 2300/303; A63F 13/58

(57) ABSTRACT

A storefront may displayed in a dashboard display of a game system. The storefront may allow for procuring of ability to play video games on the game system. The storefront may be dynamically displayed, or not displayed, based on monitored conditions relating to a game player's actions relating to video games.

### CROSS REFERENCE TO RELATED APPLICATION

This application claims the benefit of the filing date of U.S. Provisional Patent Application No. 62/755,284, filed on Nov. 2, 2018, the disclosure of which is incorporated by reference herein.

### BACKGROUND OF THE INVENTION

The present invention relates generally to video games, and more particularly to event driven presentation of options for video game procurement.

Video games provide fun and enjoyment for many. Video games allow users to participate in a variety of simulated activities. Video games allow users to perform roles and experience activities that the users may not be able or desire to experience directly, whether due to cost, danger, or equipment concerns, or simply due to a role or activity being a fantasy.

In some cases, playing of video games can be a solitary experience, with for example a single game player playing a video game, on their own. In other cases video game play may include multiple players, but the multiple players may not know one another, and may not particularly care or have an interest in when other players achieve accomplishments in the video game, particularly when not then engaged in video game play with or against those players. This possible lack of engagement with other game players may detract from video game play.

Game players may also tend towards playing a particular game, perhaps repeatedly, and perhaps to the exclusion of other games, other games which may broaden experiences of the game player. The other games may be ones that the game player would also enjoy, if only the game player knew of such games. In some cases the game player may merely not know of the opportunities presented by other games, even though other game players may have such knowledge. In some cases the game player may also have difficulty in learning of such games, or finding an opportunity to obtain such games at a time of interest, given the cornucopia of available video games.

### BRIEF SUMMARY OF THE INVENTION

Aspects in accordance with some embodiments of the invention provide a method of providing video game product procurement, comprising: determining that a condition for display of video game procurement options has been triggered; and providing for display of video game procurement options on a dashboard display of a video game system.

In some embodiments the determining that a condition for display of video game procurement options has been triggered comprises determining that a current time of day, or current day of week, or current date of month or year correspondingly matches a time of day, day of week, or date of month or year of prior procurement of a video game by a game player associated with the video game system. In some embodiments the determining that a condition for display of video game procurement options has been triggered comprises determining that a predetermined number of friends of a game player associated with the video game system have previously procured a right to play a particular video game. In some embodiments the determining that a condition for display of video game procurement options has been triggered comprises determining that a predetermined number of friends of a game player associated with the video game system are currently playing a particular video game. In some embodiments the determining that a condition for display of video game procurement options has been triggered comprises determining that a game character of game player associated with the video game system has achieved a predetermined performance objective. In some embodiments the determining that a condition for display of video game procurement options has been triggered comprises determining that a new game has been released for play by game players.

In some embodiments the display of video game procurement options include displayed options for procuring one more video games. In some embodiments the one or more video games are selected based on one or more events on which the determination that the condition for display of video game procurement options has been triggered is based.

These and other aspects of the invention are more fully comprehended upon review of this disclosure.

### BRIEF DESCRIPTION OF THE FIGURES

FIG. 1 diagrammatically illustrates a user interface dashboard relating to entry to video game play, in accordance with aspects of the invention.

FIG. 2 illustrates a networked video game system in accordance with aspects of the invention.

FIG. 3 is a flow diagram of a process for displaying a storefront on the dashboard, in accordance with aspects of the invention.

FIG. 4 is a flow diagram of a process for determining if a storefront should be displayed on the dashboard, in accordance with aspects of the invention.

FIG. 5 is a flow diagram of a process for determining video game goods to be displayed in the storefront, in accordance with aspects of the invention.

### DETAILED DESCRIPTION

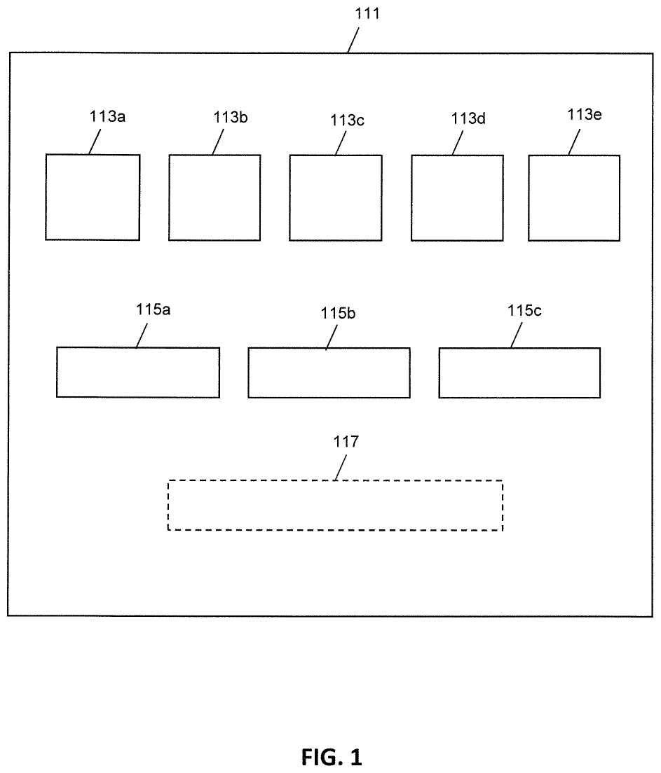

FIG. 1 diagrammatically illustrates a user interface dashboard relating to entry to video game play, in accordance with aspects of the invention. The user interface dashboard may be displayed, for example, as an initial screen display for a game device, for example after powering of or completion of starting the game device, or between game play sessions using the game device. In the embodiment of FIG. 1, the dashboard may display a plurality of selectable icons 113a-e for beginning or resuming play of any of several video games. In some embodiments the video games may be video games already procured for use on the game device. In some embodiments the selectable icons may also be for video games which may be played on demand from the game device, without regard to whether the video games were previously procured for play on the game device. In the dashboard of FIG. 1, a plurality of advertisements 115a-c are displayed in an area below the selectable icons for beginning or resuming play of the video games.

The dashboard additionally includes one or more display areas for displaying a selectable option or link for use in procuring further video games for play on the game device. In FIG. 1, one such display area is shown, below the advertisements, as a selectable icon or a portion of the display with multiple selectable areas 117. In some embodiments the display area 117 may be considered a storefront. The storefront in FIG. 1 is indicated as a dashed box, with the dashes indicating that the storefront may only be displayed on the dashboard from time to time. The storefront may display indications of one or more particular video games which may be procured. Selection of the storefront, for example by way of a user input to the game device, may provide for display of further displays to be used for procurement of a particular video game, or may provide directly for procurement of the particular video game.

In various embodiments the storefront may only be displayed in response to occurrence of particular predefined events. For example, the storefront may only be displayed at times during which it may be determined that a game player associated with the game device may have reason to desire to procure a particular video game. In some embodiments the storefront may be displayed to allow procurement of a particular video game if a predetermined number of game players identified as the game player's friends have procured the particular video game for play on their own game devices, of if a predetermined number of game players identified as the game player's friends are currently playing the particular video game. Similarly, the storefront may be displayed at times having a correspondence to prior times at which the game player procured a video game for play, or upon new public availability of video games, particularly video games with similarities to those already procured by the game player.

In some embodiments the game device may determine whether the storefront should or should not be displayed on the dashboard, and/or contents of the storefront. In some embodiments a server in communication with the game device may determine whether the store front should or should not be displayed on the dashboard, and/or contents of the storefront.

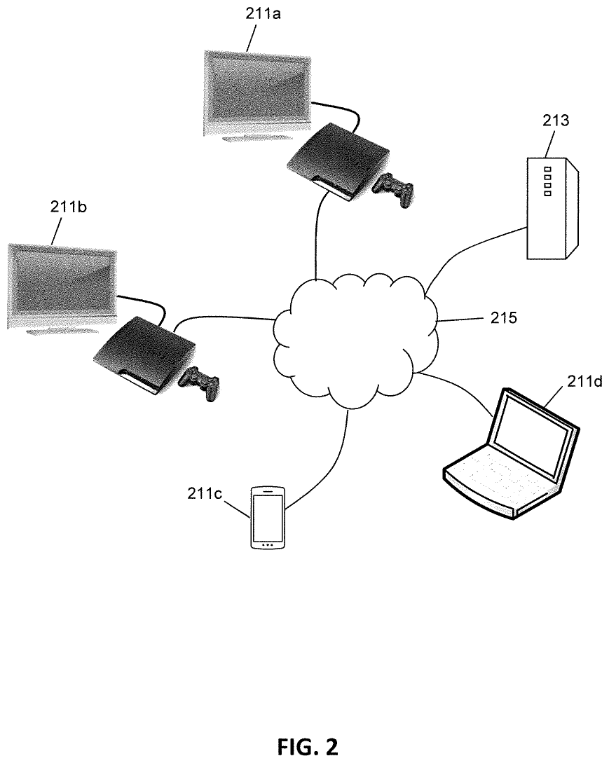

FIG. 2 is a semi-block diagram of a system in accordance with aspects of the invention. The system includes a plurality of game devices 211a-d coupled to each other and a game server 213 over a network 215, which may be for example the Internet. The game devices, and the server, may be considered compute devices. In some embodiments the game server may be a plurality of servers, for example with one of the servers providing information to game devices regarding the dashboard of FIG. 1, and in some embodiments links to other servers for functions relating to the actual playing of video games. In some such embodiments the server providing the information regarding the dashboard may also receive information relating to the actual play of video games from the other servers, as well as possibly the game devices.

The game devices 211a and 211b are shown as including a game console having at least one processor, a game controller, and a display. The game device 211c is shown as a smartphone, including at least one processor, a display device, and a touchscreen. The game device 211d is shown as a personal computer, of the laptop type in FIG. 2. More generally, in various embodiments the game devices may instead or in addition comprise a personal computer, a tablet computer, a smart phone, and/or some other compute device, each configured for video game play. In addition, for purposes of illustration, only a small number of game devices are shown in FIG. 2, in most embodiments the number of game devices may be over a thousand, and may be an order of magnitude or orders of magnitude greater than that. In some embodiments, however, the game devices may only consist of game consoles.

The game devices are configured, or configurable, for play of a video game, for example a single player and/or multi-player video game. During play of the video game, a game player utilizes the game controller or other input devices of a game device to control actions of a game character associated with the game player. The game character, responsive to commands provided by the game controller, is in and interacts with a virtual world and its other inhabitants, some of whom may be game characters controlled by other game players and some of whom may be game characters controlled by the video game itself. In some embodiments the game devices are configured to provide information regarding whether game play is occurring, and/or status of game play, to the game server. In some embodiments, for example in multi-player video games, the game server may receive information regarding game play status from the game devices, with the game server distributing the game play status to the various game devices. In some embodiments the game server may instead receive requests for game character actions from the game devices, with the game server determining game play status and distributing information regarding game play status to the game devices.

In some embodiments the game devices are also configured to display a dashboard display, for example the dashboard display of FIG. 1, on display devices of the game devices. In some embodiments only games devices in the form of game consoles may be configured to display the dashboard display. In addition, in some embodiments the dashboard display may also be displayed on a device not configured for game play, but in communication with the game server. For example, in some embodiments a game player may have a smartphone not configured for game play, with game play instead for example occurring on a game console, but the smartphone may be configured to display the dashboard display, instead of or in addition to the game console of the game player.

In some embodiments, the game device may receive information from the game server relating to video games which may be procured for play on the game device, with the game device determining if display of a storefront should be displayed for those video games, or some of those video games. In some embodiments the server may receive information game devices, and the server may determine if display of the storefront should be displayed, and if so, for which video games.

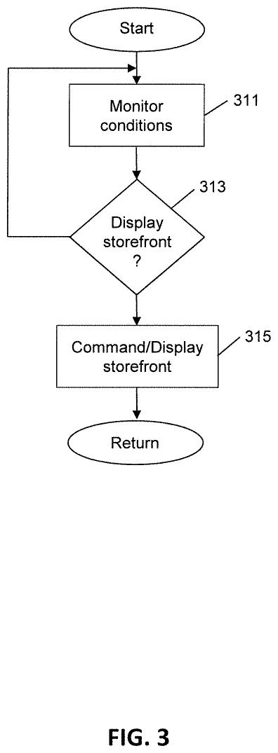

FIG. 3 is a flow diagram of a process for displaying a storefront on the dashboard, in accordance with aspects of the invention. In some embodiments the process is performed by the system of FIG. 2. In some embodiments the process, or part of the process, is performed by a server, for example the game server of FIG. 2. In some embodiments the process, or part of the process, is performed by a game device, for example a game device of FIG. 2. In some embodiments the process is performed by one or more processors, for example configured by program instructions.

In block 311 the process monitors conditions to determine if a storefront should be displayed on a dashboard. In various embodiments the process may do so for a plurality of game players, which in some embodiments may be all game players who have previously procured a particular video game, previously requested inclusion in a particular service (for example a service providing for the storefront on the dashboard), or, in some embodiments, all game players. In some embodiments the process has been permitted, for example by the game player and/or others as may be appropriate, to receive information as to some or all of identities of friends of a game player, video games previously procured by the friends of the game player, video games currently being played by friends of the game player, video games previously procured by the game player (and in some embodiments time and date of procurement), and in-game accomplishments of game characters controlled by the game player. In addition, in some embodiments the process may receive information regarding video games newly available for procurement, and/or video games which may be subject to a promotion of benefit to the game player. In some embodiments the process also receives, or maintains, information regarding current time, day, and date.

In some embodiments the process may monitor the current time, day, and date, for purposes of comparing the current time, day, and date to times of day, day of week, and dates that a particular game player previously procured video games. For example, a particular game player may procure video games every last Friday of the month, and/or at 9 PM, or every December 26. In some embodiments the process may monitor how many friends of a particular game player procured particular video games. In some embodiments the process may monitor how many friends of a particular game player are currently playing a particular video game, and in some embodiments whether the particular game player previously procured that particular video game. In some embodiments the process monitors status of game characters controlled by the particular game player, for example for purposes of determining whether one of those game characters have achieved a particular predetermined achievement. In some embodiments the process may monitor promotion announcements for video games.

In block 313 the process determines whether a storefront should be displayed on the dashboard for a particular game player. As with operations of block 311, in various embodiments the process may do so for the plurality of game players. In some embodiments the process determines, for a particular game player, that the storefront should be displayed on the dashboard if any of a plurality of conditions are true. In some embodiments the conditions are the conditions monitored in block 311. In some embodiments the process determines the storefront should be displayed on the dashboard for a particular game player if the current time, day, and/or date is within a predetermined time period of times when the particular game player previously procured a video game, or a predetermined number of video games, which may be a plurality of video games. In some embodiments the process determines the storefront should be displayed on the dashboard for a particular game player if a predetermined number of friends of the game player have procured a particular video game within a preceding predetermined period of time, or the total number of such friends has reached the predetermined number within a preceding predetermined period of time. In some embodiments the process determines the storefront should be displayed on the dashboard for a particular game player if a predetermined number of friends of the game player are currently playing a particular video game. In some embodiments the process determines the storefront should be displayed on the dashboard for a particular game player if a game character controlled by the particular game player has achieved a predetermined accomplishment within a preceding predetermined period of time. In some embodiments the process determines the storefront should be displayed on the dashboard for a particular game player if a promotion for a particular video game, or any video game in some embodiments, or any particular video game previously flagged as of interest to the particular game player, is active.

If the storefront is to be displayed on the dashboard, the process continues to block 315, otherwise the process returns to operations of block 311.

In block 315 the process commands display of the storefront on the dashboard for a particular game player. In some embodiments the process displays the storefront on the dashboard, if the dashboard is displayed on a display of a game device of the particular game player. In some embodiments the process determines video games to be featured on the storefront. In some embodiments a server provides a request to display the storefront to a game device. In some embodiments the server provides information of video games to be featured on the storefront to the game device, with the request to display the storefront in some embodiments and in response to a request from the game device for such information in other embodiments. In some embodiments the game device commands display of the storefront on the dashboard.

The process thereafter returns.

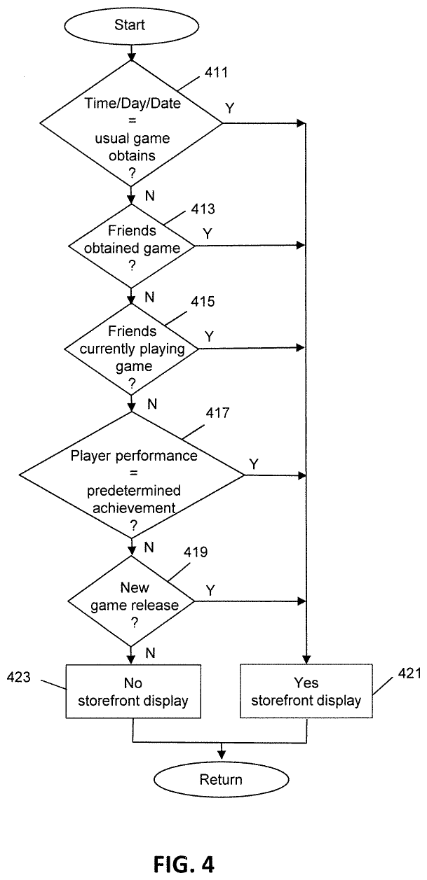

FIG. 4 is a flow diagram of a process for determining if a storefront should be displayed on the dashboard, in accordance with aspects of the invention. In some embodiments the process, or part of the process, is performed by a server, for example the game server of FIG. 2. In some embodiments the process, or part of the process, is performed by a game device, for example a game device of FIG. 2. In some embodiments the process is performed by one or more processors, for example configured by program instructions. In some embodiments the process of FIG. 4 performs operations of block 313 of the process of FIG. 3. In some embodiments the process of FIG. 4 is performed for a plurality of game players, for example as discussed with respect to the process of FIG. 3. In various embodiments order of execution of blocks 411-419 may be varied from what may be explicitly or implicitly set forth, operations of those blocks may be performed as part of other processes, or the operations of those blocks may be performed in some other manner.

In block 411 the process determines if a current time, day or date is equal to or within a predetermined time, day or date corresponding to a time a particular game player previously procured ability to play a video game. If so, the process goes to block 421 and sets a flag indicating a storefront should be displayed in a dashboard of the particular game player. Otherwise the process continues to block 413.

In block 413 the process determines if a predetermined number of friends of the particular game player have procured ability to play a particular video game, in some embodiments at a predetermined time or within a predetermined period of time. If so, the process goes to block 421 and sets a flag indicating a storefront should be displayed in a dashboard of the particular game player. Otherwise the process continues to block 415.

In block 415 the process determines if a predetermined number of friends of the particular game player are currently playing a particular video game. In some embodiments the process additionally determines whether the particular game player has not previously procured ability to play the particular video game. If so, the process goes to block 421 and sets a flag indicating a storefront should be displayed in a dashboard of the particular game player. Otherwise the process continues to block 417.

In block 417 the process determines if a game character of the particular game player has achieved a predetermined accomplishment, in some embodiments within a predetermined time of the current time. If so, the process goes to block 421 and sets a flag indicating a storefront should be displayed in a dashboard of the particular game player. Otherwise the process continues to block 419.

In block 419 the process determines if a new video game has become procurable for play, in some embodiments within a predetermined time of the current time. If so, the process goes to block 421 and sets a flag indicating a storefront should be displayed in a dashboard of the particular game player. Otherwise the process continues to block 423.

In block 423 the process determines that the flag indicating a storefront should be displayed in a dashboard of the particular game player should not be set, or in some embodiments resets the flag to indicate that the storefront should not be displayed in a dashboard of the particular game player.

The process thereafter returns.

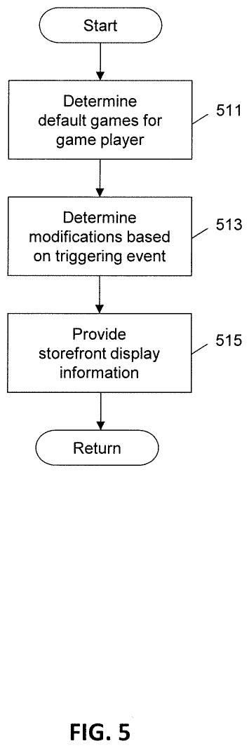

FIG. 5 is a flow diagram of a process for determining video game goods to be displayed in the storefront, in accordance with aspects of the invention. In some embodiments the process, or part of the process, is performed by a server, for example the game server of FIG. 2. In some embodiments the process, or part of the process, is performed by a game device, for example a game device of FIG. 2. In some embodiments the process is performed by one or more processors, for example configured by program instructions. In some embodiments the process of FIG. 5 performs at least some of the operations of block 315 of the process of FIG. 3. In some embodiments the process of FIG. 5 is performed for each of a plurality of game players.

In block 511 the process determines default video games available to be procured for game play that should be associated with a storefront for a particular game player. In some embodiments the default video games are the same for all game players. In some embodiments the default video games may differ across game players. In some embodiments the default video games are video games of a same type of video game as last procured or played by the particular game player. For example, if the particular game player most recently procured, or most recently played, a first person shooter type video game, then the default video games may all be first person shooter type video games.

In block 511 the process modifies which video games should be associated with the storefront for the particular game player based on a condition which resulted in triggering of display of the storefront in the dashboard for the particular game player. For example, if play of a particular video game by a predetermined number of friends of the game player triggered display of the storefront, in response the storefront may include the particular video game. In some embodiments the storefront may include the particular video game in addition to the default video games. In some embodiments the storefront may replace one of the video games with the particular video game. In some embodiments the storefront may include the particular video game, and exclude all other video games.

In block 513 the process provides storefront display information. In some embodiments the storefront display information comprises an indication of the video games to be included in the storefront. In some embodiments the information is provided by a server to a game device associated with the particular game player.

The process thereafter returns.

Although the invention has been discussed with respect to various embodiments, it should be recognized that the invention comprises the novel and non-obvious claims supported by this disclosure.

What is claimed is:

1. A method of providing video game product procurement, comprising:
determining that a condition for display of video game procurement options has been triggered; and
providing for display of video game procurement options on a dashboard display of a video game system.

2. The method of claim 1, wherein the determining that a condition for display of video game procurement options has been triggered comprises determining that a current time of day, or current day of week, or current date of month or year correspondingly matches a time of day, day of week, or date of month or year of prior procurement of a video game by a game player associated with the video game system.

3. The method of claim 1, wherein, the determining that a condition for display of video game procurement options has been triggered comprises determining that a predetermined number of friends of a game player associated with the video game system have previously procured a right to play a particular video game.

4. The method of claim 1, wherein the determining that a condition for display of video game procurement options has been triggered comprises determining that a predetermined number of friends of a game player associated with the video game system are currently playing a particular video game.

5. The method of claim 1, wherein the determining that a condition for display of video game procurement options has been triggered comprises determining that a game character of game player associated with the video game system has achieved a predetermined performance objective.

6. The method of claim 1, wherein the determining that a condition for display of video game procurement options has been triggered comprises determining that a new game has been released for play by game players.

7. The method of claim 1, wherein the display of video game procurement options include displayed options for procuring one more video games.

8. The method of claim 7, wherein the one or more video games are selected based on one or more events on which the determination that the condition for display of video game procurement options has been triggered is based.
